(19) United States
(12) Patent Application Publication
(10) Pub. No.: US 2010/0308579 A1
(43) Pub. Date: Dec. 9, 2010

(54) INTEGRAL FACE SEAL

(75) Inventors: Robert K. Snyder, Andover, MN (US); Thomas P. Peterson, Chaska, MN (US)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: ENTEGRIS, INC., Bellerica, MA (US)

(21) Appl. No.: 12/741,153

(22) PCT Filed: Nov. 3, 2008
(86) PCT No.: PCT/US2008/082291

§ 371 Date: Aug. 11, 2010

(30) Foreign Application Priority Data
Nov. 2, 2007 (US) 60985103

(51) Int. Cl. F16L 47/00

(52) U.S. Cl. 285/382; 285/423

(57) ABSTRACT

A fluid seal generally comprising a first fitting portion (50) and a second fitting portion (28), wherein at least one of the fitting portions can be deformed or deflected in a sealing relationship relative to the other fitting portion to form the fluid seal. A fitting includes a first fitting portion comprising a small projection (52) extending from a substantially planar surface. The fitting further includes a fitting portion comprising a substantially planar second surface (59). A fluid seal is created by forcing the small projection of the first fitting portion and substantially planar surface of the second fitting portion together. As they are forced together, the projection deforms to form the fluid seal. The fitting can be used to connect tubes, pipes, a valve, a manifold, and combinations thereof. The sealing method can also be used to protect the components of a pressure sensor from the corroding effects of process fluid vapors.

### RELATED APPLICATIONS

This application claims the benefit of U.S. Provisional Application No. 60/985,103, entitled O-RINGLESS FITTINGS, filed Nov. 2, 2007, said application being hereby fully incorporated herein by reference.

### TECHNICAL FIELD

The present disclosure generally relates to fluid seals. More particularly, embodiments of the present disclosure relate to integral fluid face seals for devices, such as, for example, pressure sensors, flow meters, and liquid filtration devices used in the processing of microelectronics.

### BACKGROUND

Conventional fluid seals for use in sensors, flow controllers, and other operative fluid devices conventionally comprise elastomeric O-rings or gaskets. Although such seals can be effective at sealing in most environments and are relatively inexpensive, such seals are not effective for all environments. As an example, in semiconductor processing, certain chemicals such as hydrofluoric acid may attack many conventional sealing materials and may diffuse through inert polymers such as PFA or PTFE. Even miniscule amounts of such chemicals diffusing through housings or seals can attack materials including electronics and any metallic materials resulting in deficient and inoperative devices. O-rings made of chemically resistant materials (e.g., KALREZ®) are often used, however, these O-rings can be expensive, and caustic vapors can still permeate through the O-rings and adjacent housing or component bodies causing contamination and component failure.

One problematic device is a pressure sensor that utilizes circuity. See for example U.S. Pat. No. 6,612,175, herein incorporated in its entirety. The use of pressure sensors in ultra-pure processing environments requires that the pressure sensor be non-contaminating. Ultra-pure processing of sensitive materials typically requires the use of corrosive fluids. Susceptibility to contamination of the sensitive materials during the manufacturing process is a significant problem faced by manufacturers. Various manufacturing systems have been designed to reduce the contamination of the sensitive materials by foreign particles, ionic contaminants, and vapors generated during the manufacturing process. Processing of the sensitive materials often involves direct contact with caustic fluids. Hence, it is critical to deliver the caustic fluids to the processing site in an uncontaminated state and without foreign particulate.

Various components of the processing equipment are commonly designed to reduce the amount of particulate generated and ions dissolved into the process fluids, and to isolate the processing chemicals from contaminating influences. The processing equipment typically includes liquid transporting systems that carry the caustic chemicals from supply tanks through pumping and regulating stations and through the processing equipment itself. The liquid chemical transport systems, which include pipes, pumps, tubing, monitoring devices, sensing devices, valves, fittings and related devices, are frequently made of plastics resistant to the deteriorating effects of the caustic chemicals. Metals, which are conventionally used in such monitoring devices, cannot reliably stand up to the corrosive environment for long periods of time. Hence, the transport, monitoring and sensing devices must incorporate substitute materials or remain isolated from the corrosive fluids.

The process equipment and instrumentation must be highly reliable in these ultra-pure processing systems. For example, it can be very expensive if a semiconductor or pharmaceutical line is shut down for any reason, for any length of time. For example, in the past, pressure transducers have commonly employed fill fluids to transmit pressure from the process to the sensor itself. The fill fluids are separated from the process by an isolator diaphragm of one sort or another. Failure of this isolator diaphragm and subsequent loss of fill fluid into the process can cause loss of product and require system cleaning before restarting operations. Further, O-rings can be used to isolate components of the pressure sensor. However, vapor from corrosive chemicals can permeate through the conventional O-ring seal and corrode pressure sensor components and, ultimately, the pressure sensor fails.

Also, the processing equipment commonly used in semiconductor manufacturing has one or more monitoring, valving, and sensing devices. These devices are typically connected in a closed loop feedback relationship and are used in monitoring and controlling the equipment. These monitoring and sensing devices must also be designed to eliminate any contamination that might be introduced. The sensing devices may include pressure transducer modules and flow meters having pressure sensors. It may be desirable to have a portion of the pressure sensor of the pressure transducer or flow meter in direct contact with the caustic fluids. Thus, the surfaces of the pressure sensor in direct contact with the caustic fluids should be non-contaminating. Therefore, it is preferable that those portions of the pressure sensor in direct contact with caustic fluids be made of non-porous materials.

Further, the processing equipment also generally includes flow components such as tubing, pipes and fittings. Because the fluids may be handled under significant pressure, and contamination is an issue, as noted above, seals such as O-rings and flexible flat gaskets can be used. In certain industries, such as the semiconductor industry, metallic components and conventional gaskets and O-rings are not used because the fluid may be contaminated by the fluid system component parts, or may react with the component parts. Therefore, to avoid the potential of contaminated fluid and/or damage to processing equipment, the fluid handling parts, for example, tube, pipes, fittings, couplings, and valves, can be made of fluoropolymers, for example, PFA and PTFE. In the case of seals, for example O-rings, the O-ring can be formed with an elastomeric material and encapsulated in a fluoropolymer coating so that the seal remains inert. However, O-rings structured in this way are subject to degradation and are expensive. Hence, it would be advantageous to provide a sealing device, other than an O-ring, or an improved O-ring.

Various fluoropolymer-based fittings and couplings have evolved for making connections between fluoropolymer components that do not utilize O-rings. One typical type of fitting is known in the industry as a FLARETEK® fitting. In such a fitting an elongate tapered nose section with a threaded neck engages within a tubular end portion, which is flared to fit over the tapered nose section. The flared section will have an inside cylindrical surface that has an inside diameter sized for the outside diameter of an outside cylindrical surface of the nose section. The nose section thus “telescopes” into the flared section. A nut tightens the flared section onto the nose, creating a seal between the fitting body and the flared portion of the tubing portion. The flared end of the tubing is generally formed by heating the tubing and shaping the heated malleable tubing end into the desired flared configuration using steel forms.

Various other types of fluoropolymer fittings are known in the art. Some utilize separate gripper portions or internal ferrules. See for example U.S. Pat. Nos. 3,977,708 and 4,848,802. For connections between fluoropolymer valves and components such as fluoropolymer manifolds, sealing integrity between the components is typically accomplished by gaskets or fluoropolymer covered O-rings. In addition, in applications where the process fluid flowing through a seal can be prone to crystallization, small volumes of dead space around a radial or face-seal O-ring can cause the process fluid to crystallize, thus leading to leaks at the seal or other undesirable affects to the process fluid. Also, burrs or other surface defects or features on O-ring sealing surfaces can provide additional leak points between devices.

Further, some O-ringless designs utilize a gasket made of chemically resistant materials (e.g., KALREZ®). However, these designs can require a very large closure force and can be expensive. In certain instances annular tongue-in-groove connections without O-rings or gaskets have been successfully utilized. These connections have the disadvantage that they must be precisely machined, i.e., tolerances of 0.0005 inches, and it can be difficult to properly align the mating pieces. Moreover, such connections are vulnerable to nicks and scratches which can compromise the integrity of the connection. Such a tongue-in-groove fitting is illustrated by U.S. Pat. No. 5,645,301. U.S. Pat. Nos. 3,977,708, 4,848,802, and 5,645,301 are incorporated herein by reference.

There is therefore a need for an improved fluid seal for use in an ultra-pure fluid handling system, for use in, for example, pressure sensors, valves, and fittings. Further, there is need for an improved O-ringless fluid seal for use in fluid systems, such as for use with liquid filtration devices for microelectronics process fluids.

### SUMMARY OF THE INVENTION

The fluid seal according to certain embodiments generally comprises a first mating portion and a second mating portion. A fluid seal at fitting is created by the coupling of the first and second mating portions. As the first and second mating portions are coupled, at least one of first and second mating portion can be deformed, deflected, or otherwise distorted in a sealing relationship relative to the other respective mating portion to form the fluid seal.

In one embodiment, a seal coupling includes a first mating portion having an axis, a first radially extending annular surface about said axis, having a fluid conduit positioned within said annular surface, and an annular sealing projection extending axially from said annular surface and having a top curved surface. The sealing coupling further including a second, mating portion comprising a second surface oriented to tangentially engage the top curved surface of the small projection with the tangential engagement in a plane substantially normal to the axis.

In certain embodiments, a sealing coupling comprises a first mating portion and a second mating portion wherein forcing the two mating portions together creates a sealing connection between two components. The fluid seal is created by forcing an annular projection of the first mating portion against a second surface of a second mating portion such that the second surface is engaged at the axially most forward position of the annular projection. As the two mating portions are forced together the projection deforms, increasing the contact area between the first mating portion and the second mating portion. Mating with the normal tangential surface of the mating portion, the top curved surface of the first mating portion abuttingly engages the normal tangential surface of the second mating portion, thus together forming the integral face fluid seal. The seal coupling does not include use of an O-ring or gasket. The seal coupling can be used for coupling a liquid filtration device to a filtration housing in a microelectronics process fluid system; to connect tubes, pipes, valves and manifolds.

In another embodiment, a fluid sealing coupling comprises a first mating portion and a second mating portion with a common axis for creating a fluid sealing connection between two components. The first mating portion has a proximate end for mating with the proximate end of the second mating portion. The first mating portion and the second mating portion each have a respective distal end operably attached to a respective component. The first mating portion has a circular periphery, an axial annular face extending radially, a bore within the annular face, and at least one axially projecting annular curved ridge positioned on the surface of the axial face extending around the bore. In an alternate embodiment, the first mating portion axial face can comprise two or more outwardly projecting concentric annular curved ridges. The second mating portion has a circular periphery and an axial annular face with a bore therein axially aligned with the bore of the first mating portion, wherein at least a portion of the axial face tangentially engages the annular curved ridges and is normal to the common axis of the first mating portion and second mating portion.

To form the fluid seal, the first mating portion abutingly engages the second mating portion such that curved ridge or ridges of the first mating portion are tangentially contacted by the axial face of the second mating portion. The tangential contact region being in a plane normal to the axis of the first mating portion. Axial compressive force is applied to the first mating portion and the second mating portion, such that the curved ridges of the first mating portion are deformed against the radially extending axial face of the second mating portion, forming an integral face fluid seal. In one embodiment, a spring washer, such as a Belleville washer, or a coil spring, or a plurality of coil springs are positioned adjacent the first mating portion of, for example, a first tubular member, and engages with a clamping nut to maintain pressure on the seal. Alternatively, the spring washer or other continual compressive means can be positioned adjacent the second mating portion of a tubular member, and engages with a clamping nut to maintain pressure on the seal. The bore of the first mating portion is thus in fluid communication and alignment with the bore of the second mating portion.

In another embodiment, a fluid coupling comprises a component portion of a sensor, of for example, a component of a pressure sensor. The pressure sensor is exposed to process fluids and a sensor component, for example, the surface of an isolator or diaphragm, engages a first mating portion formed in the sensor housing to form a seal. The fitting portion is preferably made of PFA (perfluoroalkoxy) or PTFE (polytetrafluoroethylene) or other fluoropolymer. The first mating portion can take the shape of an annular bump or curved ridge. The annular bump preferably has a height of 0.005 to 0.030 inches and a radius of 0.020 to 0.065 inches, and preferably a height of about 0.015 inches and a radius of about 0.045 inches. The annular bump can deform as the seal with the isolator or diaphragm is effectuated under axial compression. The isolator can be made of fluoropolymers such as CTFE (chlorotrifluoroethylene), PFA, or PTFE.

Further, in another embodiment, the sensor can include a spring washer, for example, a Belleville washer, to provide sustained axial loading in the existence of creep by the material, for example the annular bump, to maintain the sealed connection between the first mating portion and the isolator surface. In yet another embodiment, the sensor can include a trench positioned between two adjacent annular bumps, thereby facilitating dispersal of harmful vapors that may have passed beyond the seal formed by the first fitting portion. Dispersal of such harmful vapors between the first and second seals assists in preventing harmful vapors reaching and damaging sensitive sensor components. Generally, such pressure sensors are utilized in semiconductor processing applications and are further illustrated by U.S. Pat. Nos. 7,152,478 and 5,693,887, owned by the owner of the instant application and incorporated herein by reference. It is not required that the pressure sensor include an isolator layer or surface; a sapphire diaphragm can provide the planar surface to which the annular bump seal portion is mated.

A feature and advantage of embodiments of the fitting and integral face seal is that only a low engagement force is needed to bring seals together.

Another feature and advantage of embodiments of the fitting and integral face seal is that only a low sealing force is needed to energize the seal.

A further feature and advantage of embodiments of the fitting is that integral seals can be formed that can be utilized at high fluid pressures with low clamping force.

In an embodiment of the invention, a pair of fluoropolymer members comprising a first mating portion and a second mating portion each with cooperating sealing portions may be secured together using a nut and further having a Belleville washer, or spring washer or a coil spring or a plurality of coil springs to provide a constant compressive loading to the cooperating sealing portions such that where creep in said members occurs, the loading is maintained at substantially the same level whereby the integrity of the seal is maintained.

The above summary of the various representative embodiments of the invention is not intended to describe each illustrated embodiment or every implementation of the invention. Rather, the embodiments are chosen and described so that others skilled in the art may appreciate and understand the principles and practices of the invention. The figures in the detailed description that follows more particularly exemplify these embodiments.

### BRIEF DESCRIPTION OF THE DRAWINGS

These as well as other objects and advantages of this invention will be more completely understood and appreciated by referring to the following more detailed description of the presently preferred exemplary embodiments of the invention in conjunction with the accompanying drawings, of which:

FIG. 1 is a top planar view of a flow meter;

FIG. 2 is a cross-sectional view of the flow meter of FIG. 1, showing a pressure sensor with dual integral face seals;

FIG. 3 is cross-sectional view of a pressure sensor;

FIG. 4 is a cross-sectional view of a pressure sensor showing an integral face seal;

FIG. 5 is a cross-sectional view of a prior art pressure sensor;

FIG. 6 is a cross-sectional view of a prior art pressure sensor;

FIG. 7 is a cross-sectional view of a pressure sensor showing an integral face seal;

FIG. 8 is a cross-sectional elevation view of an integral face seal fitting;

FIG. 9 is the fitting of FIG. 8, depicting first and second fitting portions thereof in a coupled configuration to form a fluid seal;

FIG. 10a is a cutaway perspective view of a multiple fitting arrangement utilizing integral face seal fittings, wherein fittings are in a concentric configuration;

FIG. 10b is a cross-section of the interface of the fitting portion of FIG. 10a and a cooperating fitting portion;

FIG. 11 is a perspective view of a multiple integral face seal fitting arrangement, wherein fittings are in adjacently positioned configuration;

FIG. 12 is a cross-sectional view of a pressure sensor showing a dual integral face seal and a trench; and

FIG. 13 is a cross-sectional view of the integral seal between two tubular members.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives.

### DETAILED DESCRIPTION OF THE DRAWINGS

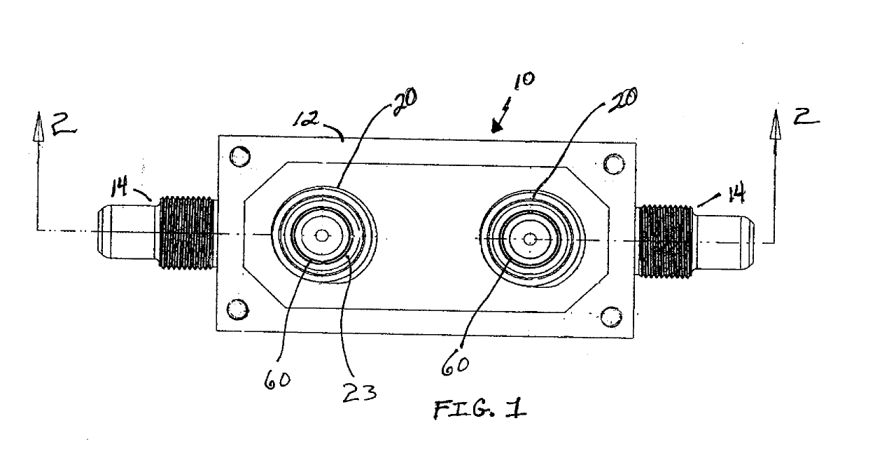

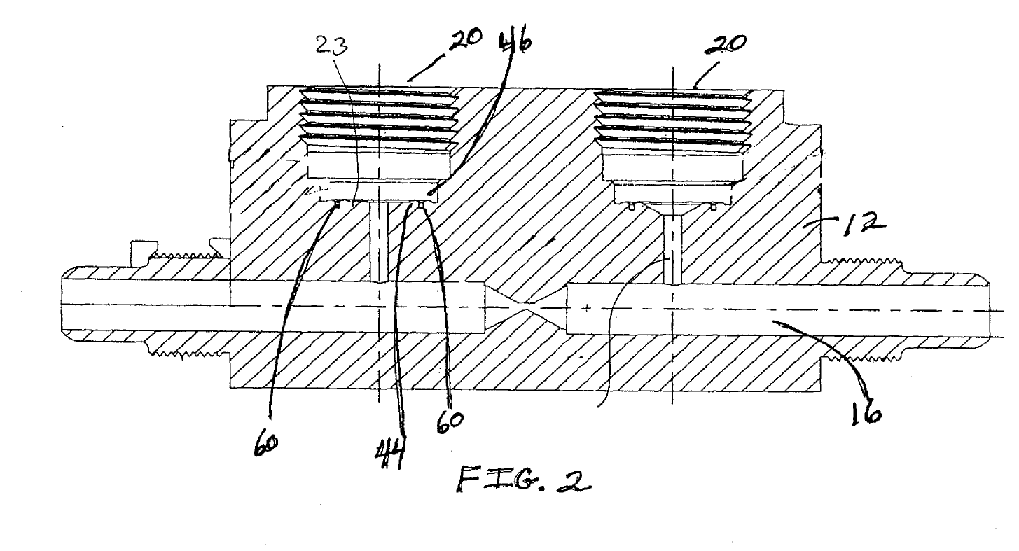

The fluid coupling according to embodiments of the invention generally comprises a first mating portion and a second mating portion. A fluid seal at fitting is created by the coupling of first and second mating portions. As first and second mating portions are coupled, at least one of first and second mating portions is deformed, deflected, or otherwise effected in a sealing relationship relative to the other respective mating portion to form the integral face fluid seal. In embodiments, first and second mating portions can be designed to be constructed of different materials or the same material. At least one of the mating portions are preferably formed of fluoropolymers such as PFA (perfluoroalkoxy) and PTFE (polytetrafluoroethylene). Referring to FIG. 1, there is shown a top perspective view of a flow meter housing 10, wherein the flow meter housing 10 includes a body 12, fittings 14, and bores 20 for two adjacent pressure sensors. A first member of a coupling according to an embodiment of the invention comprises the bottom portion 23 of the housing 10. The fittings 14 serve as an inlet and an outlet to the flow meter 10. FIG. 2 is a sectional internal view of the flow meter housing 10 taken at line 2-2 of FIG. 1. As shown in FIG. 2, a bore 16 extends through the housing 12 forming a conduit, whereby the pressure sensors are connected in-line, with a fluid flow circuit via fittings 14.

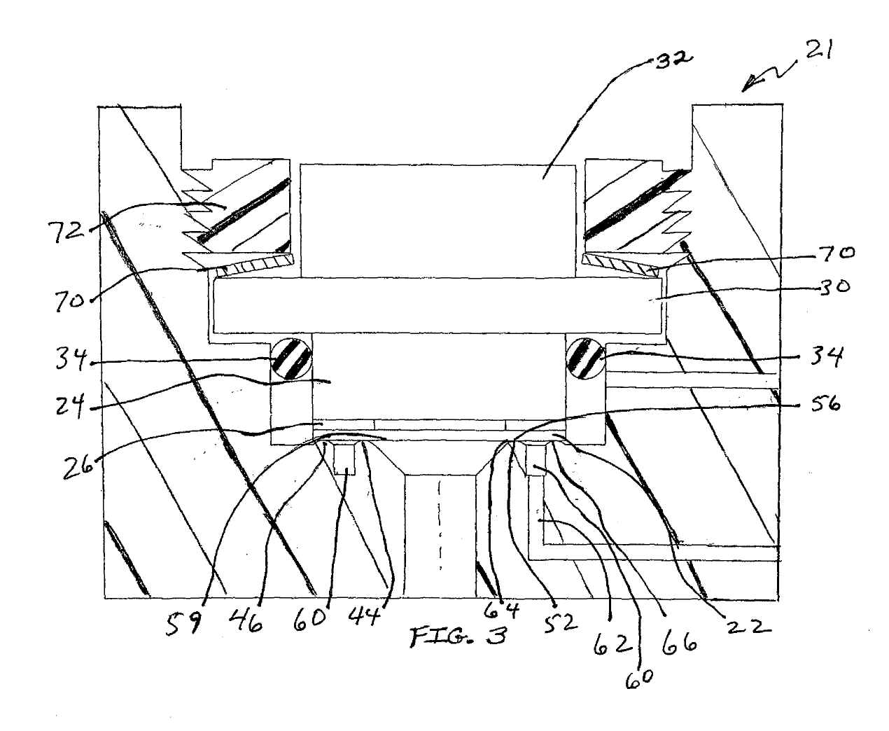

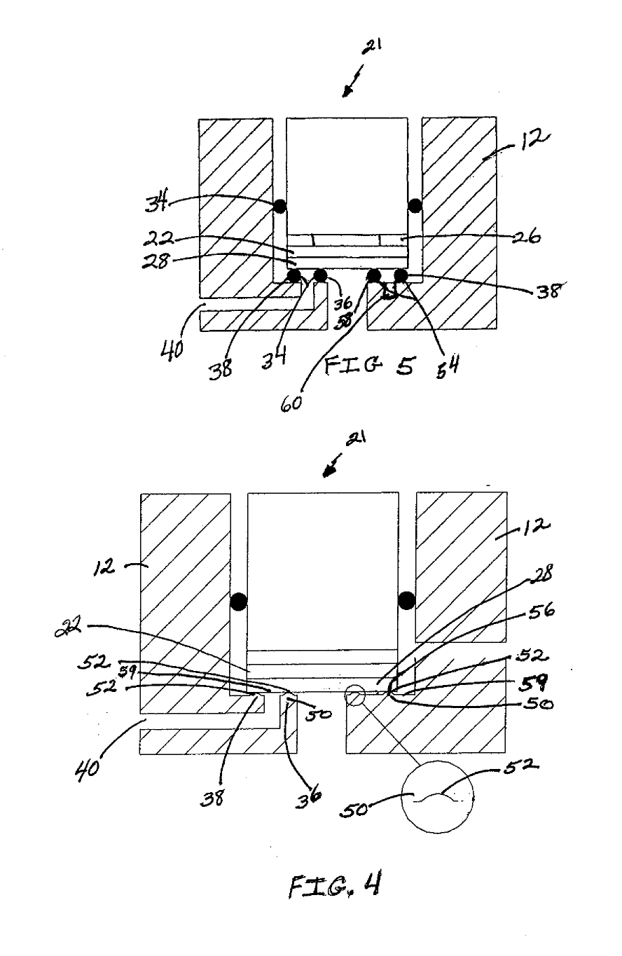

FIG. 2 shows a sectional side perspective view of additional components of an exemplary pressure sensor 21. The pressure sensor 21 as shown in FIG. 3 comprises a sensing diaphragm 22, a backing plate (generally a ceramic material) 24, silica glass bond (binder) 26 positioned between the backing plate 24 and diaphragm 22, and electrical leads (not shown). The pressure sensor 21 can also include an isolator 28, as shown in FIG. 4. The diaphragm 22 can be made of a piece of single crystal sapphire or a single crystal diamond. The layer of single crystal sapphire is non-porous and is impervious to chemical attack. Therefore, chemicals or contaminants cannot be extracted into a process stream. The isolator is generally made of an inert material, for example, from a fluoropolymer such as CTFE (chlorotrifluoroethylene), PFA, or PTFE. An example of sensor without the inventive aspects disclosed and claimed herein is disclosed in U.S. Pat. No. 6,612,175.

As noted above, the pressure sensor 21 includes a backing plate 24, a non-porous diaphragm 22, and a glass layer 26 of a high strength material that is bonded by glassing to the backing plate 24 and the non-porous diaphragm 22. The backing plate 24 provides rigidity to the structure. The rigidity of the backing plate 24 resists stresses transmitted from the housing 12 to the sensing elements on the sensor diaphragm 22. Although the backing plate 24 is not in direct contact with the process medium it is required to be mechanically stable and amenable to high temperature processes. The thermal expansion rate of the backing plate 24 should approximate closely that of the sensing diaphragm 22. While it is possible to compensate for thermal effects, a large mismatch will produce stresses during manufacture that may cause the bond between the two pieces to yield over time.

Without limitation, the non-porous diaphragm 22 is preferably comprised of a chemically inert material such as sapphire. The glass layer 26 between the sapphire and the backing plate 24 is preferably made of high bond strength borosilicate glass or other glass of suitable known construction having a high bond strength and melt temperature above 700° C. and preferably above 1000° C. The amount that the diaphragm 22 flexes is controlled by the thickness and diameter of the glass layer. The glass layer 26 may have a thickness ranging between 0.002 and 0.030 inches with 0.010 inches being preferred and an outside diameter ranging from 0.100 to 2.0 inches with 0.700 inches being preferred. The active sensing area of the diaphragm 22 may range from 0.050 to 2.0 inches with 0.400 inches being preferred. The range of thickness and diameter of the diaphragm 22 should not be construed as limiting, but that the thickness and diameter in certain applications may be further reduced or increased as desired. In this manner, the non-porous diaphragm 22 engages an inner surface of the backing plate 24.

The backing plate 24 is generally constructed of ceramic. Generally, ceramics consist of metal oxide powders that are sintered together at high temperature typically using a small amount of glass to act as a binding agent. A common ceramic is alumina which has many similar properties to single crystal sapphire. When the glass content of the alumina ceramic is kept below a few percent, the thermal expansion properties between the sapphire material and the alumina ceramic are negligibly different. To bond the sapphire to alumina ceramic by glassing, a silica glass can be pre-formed or screened onto the surface of the backing plate.

The pressure sensor 21 can further include shielding layers 30, 32, for example, a silicon nitride layer 32 and a metallization or conductive layer 30 positioned between the silicon layer 32 and the backing plate 24. In this manner the silicon nitride layer 32 acts as an electrical insulator and the metallization layer 30 blocks EMI/RFI from affecting the sensing element. The conductive or metallization layer 30 can comprise a layer of niobium, tungsten, iridium, molybdenum, tantalum, platinum, and palladium, or other material known to shield EMI and RFI. Thus, the metallization layer 30 shields the sensing element from EMI and RFI originating from above the conductive layer 30. The pressure sensor 21 can further include a gasket or O-ring seal 34 adjacent to at least a portion of an outer edge of the layers of the non-porous diaphragm 22, shielding layer(s) 30, 32 and the backing plate 24.

Sensors 21 having a sensing diaphragm 22 constructed with single crystal sapphire provide excellent protection against chemical attack. The sensor 21 can be positioned within a pressure transducer housing having primary 36 and secondary seals 38. If the primary seal 36 engages the outer surface of the sapphire diaphragm 22, the process fluid wets only the seal and the sapphire. Since seals of known suitable construction are permeable to process fluids, some process fluid will get beyond the primary seal 36. Very aggressive process fluids such as hydrofluoric acid that permeate past the primary seal 36 and secondary seal 38 may attack the joint between the sapphire diaphragm 22 and the ceramic backing plate 24. The contaminants from the corrosion of the joint may then also permeate back into the process fluids. Referring to FIG. 6, the prior art sensor is shown positioned within a pressure transducer housing 12 having vapor vent 40. The sapphire diaphragm 22 seals against the primary and secondary seals 36 and 38. A vent or drain 40 can extend from the outside of the pressure sensor housing 12 into the housing between the primary 36 and secondary 38 seal. The vent 40 can relieve pressure between the seals and/or provide a passage for vapors permeating through the primary seal 36 to exit out the pressure transducer housing 12. However, if vapors exit through the vent 40, the vapors have already been in contact with the sapphire diaphragm and the glass binder layer 26, causing corrosive damage to the sensor 21. Further, vapor can still permeate through the O-rings or gasket seals 34 (although the seals can be made of KALREZ®) and can corrode other components of the sensor, such as the electronic connections, such that the sensor 21 will fail. One of the more common reasons for failure occurs due to process fluid attack, for example, hydrofluoric acid or hydrochloric acid, on the binder 26 used to attach the sapphire disc 22 to the sensor 21.

FIG. 5 shows a sensor, wherein the primary 36 and secondary 38 seals are O-rings or gaskets 34, and are subject to attack by the corrosive process fluids, for example, hydrofluoric acid or hydrochloric acid. However, the primary 36 and secondary 38 seals are positioned at the face of the isolator 28 (or sapphire diaphragm 22). A vent port 40 is positioned between the primary 36 and secondary 38 O-ring seals, and the vent provides an exit for dissipating any harmful vapors that may have passed through the primary seal 36. The positioning of the dual seals 36, 38 at the face of the isolator 28 or sapphire diaphragm 22 and the positioning of the vent 40 between the seals, 36, 38, greatly diminishes the amount of vapor that permeates past secondary seal 38. Therefore, less vapor is allowed into contact with the glass binder layer 26 and other sensor 21 components, thereby extending the life of the sensor 21. Further, the positioning of an annular trough or trench between primary and secondary O-ring seals 58, 54, facilitates additional vapors dissipating through the trench and out the vent 40.

The sensors 2 shown in FIGS. 1, 3, and 4 show various embodiments of the current invention. Generally, the sensor 21 is exposed to the process fluid and a sensor component 22, 28, for example, an isolator 28 or a sapphire diaphragm 22, engages the seal portion 50, formed preferably of PFA or PTFE or other fluoropolymer, having a curved ridge (“bump”) 52 with preferably a height of 0.005 to 0.030 inches and a radius of 0.020 to 0.065 inches, and preferably a height of about 0.015 inches and a radius of about 0.045 inches. In certain embodiments the width of the curved ridge will be 2 to 4 times the height of the curved ridge. In certain embodiments the height will be 0.010 to 0.200 inches. In other embodiments the height will be in the range of 0.020 to 0.100 inches. In other embodiments the height will be in the range of 0.010 to 0.050 inches.

Referring to FIG. 4, the sensor 21 includes a dual seal structure at the isolator layer 28. However, the isolator layer 28 is not required, and the dual seal structure can comprise engagement with the sapphire diaphragm 22. The seal structure comprises a first mating portion 50 comprising small annular projection with a curved ridge or “bump” 52 projecting from the 57 surface of the housing 12. The seal structure further comprises a second mating portion comprising substantially of a normal tangential surface 56, relative to the top surface of the curved ridge. In this embodiment, the integral face fluid seal is created by forcing curved ridge 52 and normal tangential surface 56 of second mating portion 59 together. As they are forced together, projection 52 deforms to form the integral face seal. The surface 56 can also deform but to a much lesser extent. The second seal structure is similar to the first seal structure, wherein a first mating ° portion 50 comprising a curved ridge or “bump” 52 is forced together with normal tangential surface 56 of second mating portion 59, whereby projection 52 deforms to form the integral face seal. The embodiment shown in FIG. 4 provides for a more secure seal and a seal that will not react with the process fluids, as the seal components are composed of inert materials. The presence of vapors of the process fluids past the seal structure is diminished because the vapors do not permeate through the inert materials of the seal structure as readily as the vapors permeate through conventional O-ring or gasket seals 34 made of KALREZ®. Further, the presence of the vent 40 between the two seal structures 36, 38, any vapors that manage to pass by the first seal 36 will be vented through the housing 12. Hence, the amount of vapor that reaches the glass binder layer 26 and other sensitive sensor components is greatly reduced, thereby extending the life of the sensor 21. The glass 26 and other components of the sensor 21 will not corrode as rapidly and the sensor 21 will not fail as quickly. Test data has indicated that the lifetime of the sensor may be improved by about 10-fold to about 40-fold.

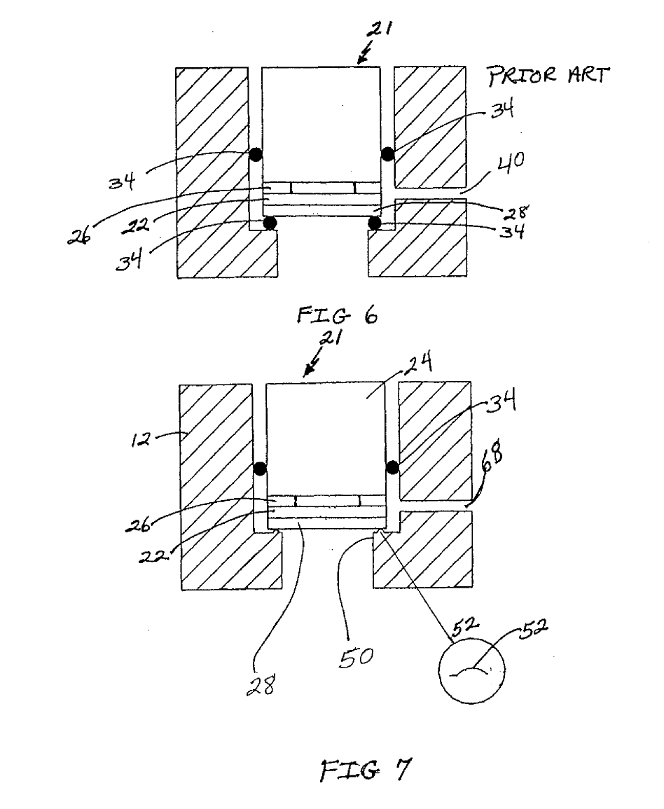

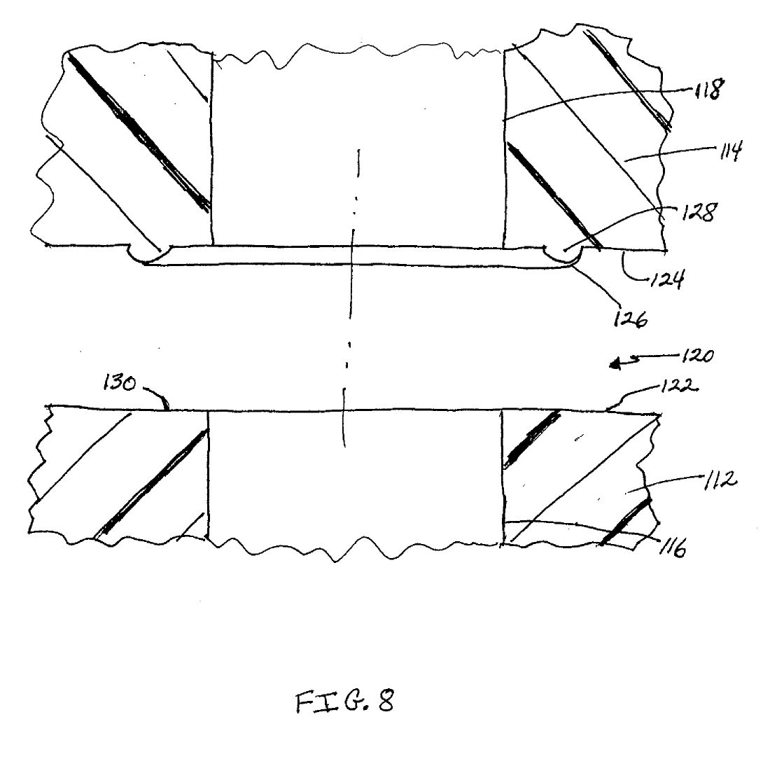

Referring to FIG. 3, the pressure sensor 21 includes the dual seal structure 44, 46, and dual seal structure 64, 66, wherein the fluid seal is created by forcing small first curved ridge or “bump” 52 and normal tangential (relative to the top surface of the curved ridge or “bump”) first surface 56 of second seal portion 59 together. As they are forced together, projection 52 deforms to form the integral face seal. The surface 56 can also deform but to a much lesser extent. The second seal structure 64, 66 is similar to the first seal structure 44, 46. The sensor includes a vent port 62, wherein the vent port 62 vents to the face of the housing 12. The vent port 62 is positioned between the two integral face seal structures 64, 66 which compose first seal arrangement 80. The vent port 62 facilitates dispersal of processing fluid vapors that may have permeated past the first seal 64. Remaining vapors must still permeate past the second seal 66, to gain access to the glass bonding surface 26 and to other components of the sensor 21. Hence, the vent port 62 assists in protecting the integrity of the sensor 21. Further, an annular trench or trough 60 is positioned between the two integral face seal structures 44, 46, which compose second seal arrangement 80. The trench 60 further assists in dispersing any vapors entering the sealant area, where the vapors in the trench 60 can permeate to the vent 62 and dissipate through the vent. In another embodiment, as shown in FIG. 7, only one seal structure, as described above, is present. However, the sensor also includes a weep port 68, which facilitates dispersal of any processing fluid vapors that may have passed the integral face seal structure. Because the primary seal structure does not include an O-ring or a gasket, but an inert material integral face seal, less vapor will pass by the seal. However, the single seal structure will not be as efficient at protection the sensor 21 components from harmful vapors as the dual seal structure, especially when the dual seal structure includes a trough or vent disposed between the two seals composing the dual seal structure.

Further, referring again to FIG. 3, the sensor 21 includes a spring washer 70, for example, a Belleville washer 70, beneath the compression nut 72. The spring washer 70 maintains pressure between the annular curved ridges or “bumps” 52 of the seal and the sapphire diaphragm 22 or, if present, the isolator layer 28. The Belleville washer 70 is particularly selected because the Belleville washer 70 has the property that the force required to compress the Belleville washer 70 is essentially constant over the full working range of the washer 70. The spring washer 70 maintains the pressure between the top of the curved ridges 52 and the sapphire diaphragm 22 with changing temperature, fluoropolymer component creep, and with curved ridge 52 deformation over time. The spring washer 70 can maintain the seal at and beyond the maximum rated pressure of the flow meter 10 of which it is a part. Although Belleville washers 70 are preferredly used, other washers, for example, wave washer or lock washer, may be suitable in particular applications in place of the Belleville washer 70.

Use of dual integral seals 44, 46 and 64, 66 eliminates the need for costly O-rings and associated critical sealing surfaces and tolerances. Further, use of the integral seal minimizes the materials that are exposed to process fluid media and associated contaminants and particles, for example, no exposure to KALREZ®. In addition, vapor permeation associated with porous O-ring materials is minimized. Addition of a spring washer 70 or a coil spring to the sensor structure improves ease of assembly by eliminating critical torque, and provides for a constant fit between the integral seal surfaces, particularly over time, even with some fluoropolymer component creep.

In another embodiment, as shown in FIG. 2, the pressure sensor 21 includes the dual seal structure 44, 46 and 64, 66 as described above for FIG. 3. The sensor 21 further comprises an annular trough or trench 60 positioned between the two seals composing the seal structures 44, 46 and 64, 66. The annular trench 60 facilitates the ready dispersal of any process fluid vapors that may have found their way past the first seals 44, 64, respectively. A sufficiently deep trench 60 can increase the life expectancy of the sensor 21 by a factor of about 10-fold. The trench 60 depth can vary between about 0.0001 inches to about 0.10 inches. The permeation rate of vapor through a weep port 68 can be decreased by more than 2 orders of magnitude with an effective trench 60 depth of 0.10 inches. Other embodiments may have trenches 0.100 inches to 0.200 inches.

Use of O-rings in the above described FIGS. 2, 3, and 4, will not provide the same seal protection as compared to the use of the projecting annular curved ridge seal structure. However, the addition of a vent or a trough/trench positioned between two O-rings positioned at the diaphragm 22 or isolator 28 surface improves the life of the sensor by dissipating harmful vapors through the vent and/or the trench.

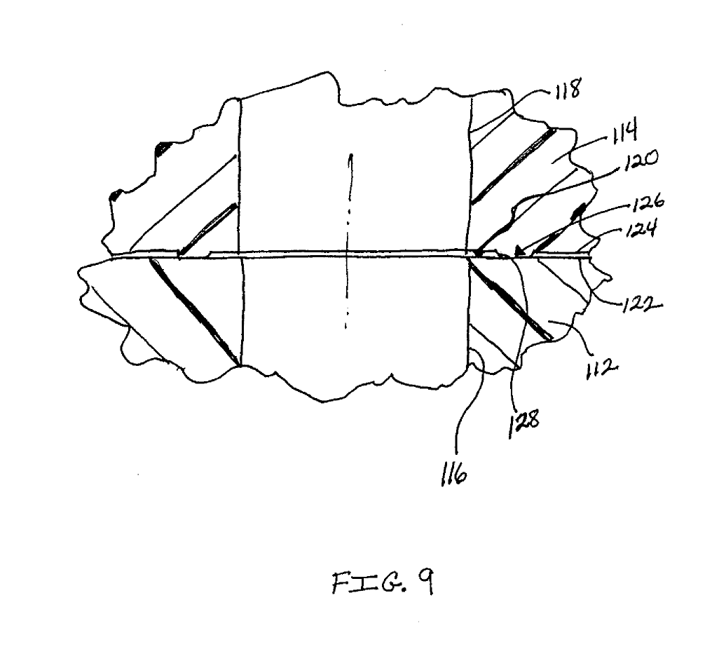

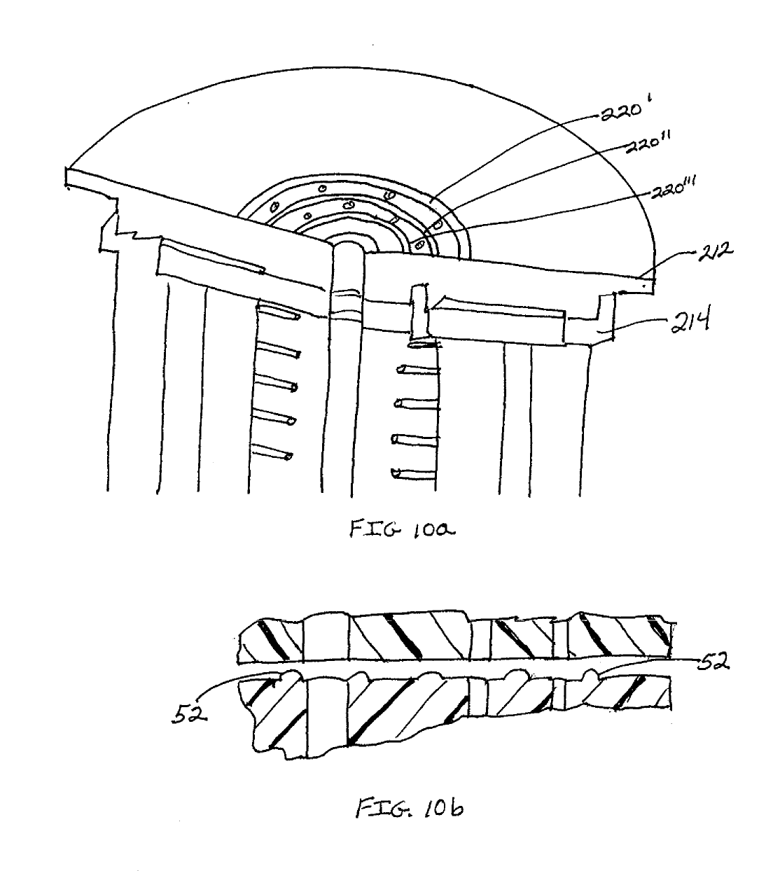

Referring to FIGS. 8 and 9, in another embodiment, the figures show two conduit portions 116, 118 of a liquid handling system that are to be joined. The conduit portions 116, 118, can be for example, portions of a liquid filtration device, portions of pipes in a liquid transport system, or valve or manifold connection. A first component 112 and a second component 114, such as of a liquid filtration device, comprise first and second fluid conduit portions 116, 118 of a fluid conduit therein, respectively, and are fluidly coupled at a coupling 120, such that first and second fluid conduit portions 116, 118 collectively form a substantially continuous fluid conduit. When coupled at coupling 120, first and second surfaces 122, 124 of first and second components 112, 114, respectively, can be in an operably abutting relationship. As depicted, first and second surfaces 122, 124 can be, but are not required to be, substantially planar.

Coupling 120 comprises a first, first fitting portion 126 comprising a small projection or curved ridge 128 extending from second surface 124. The small projection or curved ridge 128 forms an annular curved ridge in the surface 124. The surface 124 and the annular curved ridge are features of component 114. Coupling 120 further comprises a second fitting portion 130 comprising a first surface 122 that is normally tangentially oriented relative to the top of the curved ridge 128. In this embodiment, the integral face fluid seal is created by forcing annular curved ridge 128 and first surface 122 of second fitting portion 130 together. As they are forced together, curved ridge (“bump”) 128 deforms to form the fluid seal. The surface 122 can also deform but to a much lesser extent. The fluid seal thus formed is an integral face seal, similar to the integral face seals described above in the context of a pressure sensor. Hence, the integral face seal dispenses with the need for an O-ring or gasket to form the seal between the two conduit portions. The use of only two components (first and second fitting portions) can be inexpensive and can eliminate the need for expensive KALREZ® gaskets and seals.

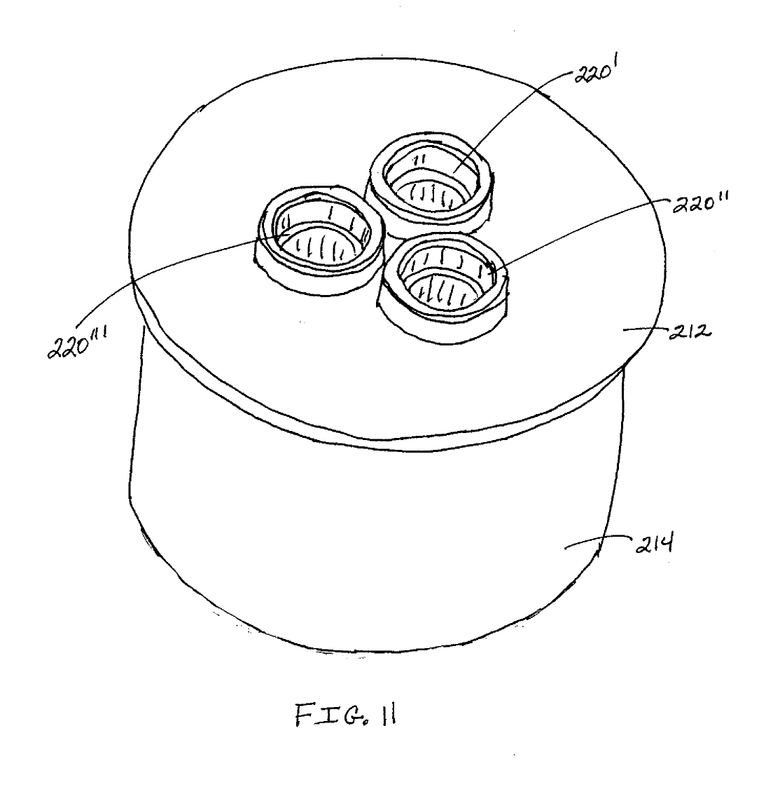

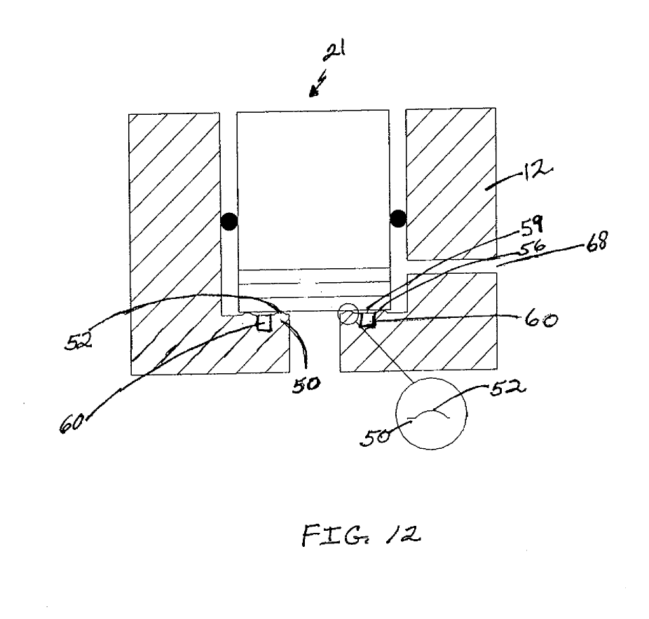

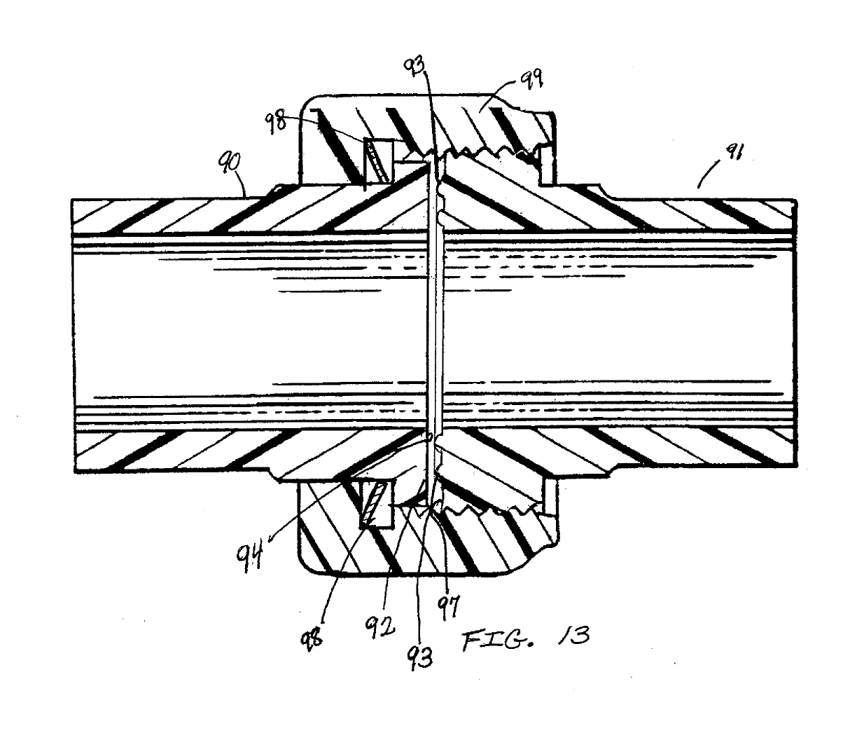

Another aspect of the present disclosure is placement of multiple fittings 220′, 220″, 220′″, such as fittings required for a photolithography filter (Inlet, Outlet, and Vent), close together to aid in the application of the engagement and sealing forces between first and second components 212, 214 of the filter. Referring to FIGS. 10a, 10b, and 11, such grouping can be either concentric (FIGS. 10a and 10b) or adjacent (FIG. 11). Such groupings can enable more concentrated engagement and tighter tolerance of a molded filter head. Due to the effects of molded-part dimensional changes during the molding and curing processes, groupings depicted in FIGS. 10 and 11 can enable tighter tolerances as compared to a linear placement of the coupling mating portions.

In another embodiment, as disclosed in FIG. 13, a sealing structure for two tubular members is shown. Tubular member 90 includes a sealing face 94 wherein the sealing face includes an axial face 92 and a surface 96. Tubular member 91 includes a sealing face 97 wherein the sealing face includes at least one annular curved ridge 93 and a surface 95. The sealing face 97 can also include a plurality of annular curved ridges 93, wherein the annular curved ridges are concentrically oriented in the axial face of tubular member 91. Sealing surface 96 is normally tangential to the top surface of the annular curved ridge 93. An axial compression force is exerted on the two faces, 94, 97, such that the annular curved ridge 93 is deformed and mated to surface 96. Further, a spring washer, for example, a Belleville washer, or coil spring 98 is positioned between the compression nut 99 and the tubular member 90. The nut 99 engages the tubular structures 90, 91 and urges the spring washer 98 toward the sealing faces 94, 97, such that the spring washer 98 exerts pressure on the annular curved ridge 93 and the tangentially normal surface 96, thus providing for a more secure integral face seal. The spring washer 98 is particularly helpful in maintaining the integral face seal, as the plastic or fluoropolymer material of the tubular members may creep.

The use of an integral face seal in applications where the process fluid flowing through a seal can be prone to crystallization can prevent small volumes of dead space around a radial or face-seal o-ring, which can cause the process fluid to crystallize, thus leading to leaks at the seal or other undesirable affects to the process fluid. Also, burrs or other surface defects or features on O-ring sealing surfaces can provide additional leak points between devices. Further, some O-ringless designs utilize a gasket made of chemically resistant materials (e.g., KALREZ®). However, these designs can require a very large closure force and can be expensive.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents.

1. A coupling device for sealingly connecting components, the coupling device comprising;
a first fluoropolymer member comprising a first mating portion having an axis, a distal end operably connectable to a component, a proximal end wherein the proximal end comprises a periphery, an annular and axial face normally positioned with respect to the axis, a centrally positioned fluid conduit extending through and defined by the fluoropolymer member and positioned in the annular face, and at least one annular curved ridge extending axially on the surface of the axial face, one of the at least one annular curved ridge extending around and positioned adjacent to the fluid conduit, the annular curved ridge being integral with the fluoropolymer member defining the fluid conduit, the annular face being entirely planar between the periphery and the fluid conduit except for each of the at least one annular curved ridge; and
a second member having an axis and a second mating portion comprising a distal end operably connectable to another component, and a proximal end wherein the proximal end comprises a periphery and an planar axial face; wherein the at least one annular curved ridge is sealingly deformable against the second mating portion axial face when the first mating portion annular and axial face and the second mating portion axial face are subject to an axial compressive force thereby forming a fluid seal, said annular curved ridge tangentially engaged in a plane substantially normal to the axis defined by the planar axial face.

2. The coupling device of claim 1 wherein a plurality of annular curved ridges are concentrically positioned on the first mating portion annular face.

3. The coupling device of claim 1 wherein the axial face has an annular trench recessed therein, the trench positioned radially outward of at least one annular curved ridge, the trench vented to the exteriorly of the device.

4. The coupling device of claim 3 wherein the trench is positioned between two annular curved ridges and the depth of the trench is greater than the height of the curved ridge with respect to the axial face is greater than the height of the annular curved ridges.

5. The coupling device of claim 1 further comprising a spring washer, wherein the spring washer is abuttingly enagageable with one of the first member and the second member for providing continual compressive force urging together the first mating portion annular and axial face and the second mating portion axial face for maintaining the fluid seal.

6. The coupling device of claim 5 further comprising a securing nut, wherein the securing nut is engageable with the first member at the first mating portion and engageable with the second member at the second mating portion and wherein a compression force exerted by the nut urges the spring washer against the second member and further compresses the first mating portion annular face against the second mating portion axial face.

7. The coupling device of claim 1 wherein the second member is operably connected to one of a valve and a flow controller.

8. The coupling device of claim 1 wherein at least one component comprises a manifold.

9. A fluid sensor for use in harsh environments, the sensor comprising:
a fluoropolymer outer housing including a housing component with a fluid flow conduit;
a diaphragm positioned in the housing component;
the diaphragm presenting a sealing surface; and
the housing component presenting a sealing surface extending around the fluid flow conduit and engaged with the diaphragm sealing surface, wherein the housing sealing surface comprises at least one annular curved ridge positioned on the housing sealing surface, said ridge integrally formed with the housing and compressed against the diaphragm sealing surface.

10. The sensor of claim 9 further comprising a backing plate adjacent the diaphragm; a glass layer adapted to be bonded to the backing plate and the diaphragm; and electrical circuitry.

11. The sensor of claim 9 wherein the housing sealing surface is abuttingly engageable with the diaphragm sealing surface, and the at least one annular curved ridge is deformable against the diaphragm sealing surface when the housing sealing surface and diaphragm sealing surface are subject to a compressive force.

12. The sensor of claim 9 wherein the housing sealing surface comprises a plurality of concentrically-oriented annular curved ridges wherein adjacent annular curved ridges have housing sealing surface disposed between the concentrically-oriented annular curved ridges.

13. The sensor of claim 10 wherein a trench is positioned between at least two adjacent annular curved ridges and the trench is vented to the exterior of the housing.

14. The sensor of claim 11 wherein a vent extending to the exterior of the housing component is positioned between at least two adjacent annular curved ridges.

15. The sensor of claim 1 further comprising a compression nut wherein the compression nut is adapted to engage with components of the sensor.

16. The sensor of claim 15 further comprising a spring washer operably engageable with the compression nut, the compression nut urging the spring washer to maintain pressure between the deformable annular curved ridges of the housing sealing surface and the diaphragm sealing surface.

17. A operative fluid device having an axis and comprising:
a first member comprising fluoropolymer body housing component, having a annular sealing face substantially normal to the axis and with a fluid flow conduit therein,
a second member comprising a fluoropolymer material and having a annular fluid flow conduit with an axial face having a annular rounded ridge axially projecting from the axial face, said fluoropolymer material subject to creep, the annular rounded ridge extending around a fluid flow conduit,
a compressive loading means for urging the axial face of the second member together with the annular sealing face of the first member such that annular rounded ridge is compressed into the annular sealing face and the compressive loading means maintains a substantially constant loading when the second member creeps.

18. The operative fluid device of claim 17 further comprising one of a valve member, a sensor member, and a filter member.

19. The operative fluid device of claim 17 or 18 wherein the compressive loading means comprises a spring washer.

20. A coupling device for sealingly connecting components, the coupling device having an axis and comprising;
a first fluoropolymer member comprising a first mating portion and having an axially projecting sealing portion;
a second member having a second mating portion for sealingly engaging the axially projecting sealing portion;
the first mating portion and the second mating portion susceptible to polymer creep;
a nut engageable to axially compressibly load the first mating portion and the second mating portion, a spring positioned positioned to be loaded by the nut for providing a constant compressive loading under creep conditions.

21. A sensor for use with harsh acids corrosive to sensor components, the sensor comprising:
a fluoropolymer housing including a housing component with a fluid flow conduit and an annular sealing face surrounding the fluid flow conduit;
a diaphragm sealingly engaged with the housing component;
a plurality of sensor components positioned in sealing proximity to the housing component and positioned to sense a characteristic of the fluid in the fluid flow conduit, at least one of the sensor components having a susceptibility to the harsh acids, one of said components sealingly engaged to the annular sealing face with a first annular seal, the annular seal radially displaced from the fluid flow conduit, a second annular seal radially displaced from the first annular seal an annular intermediate space defined between the first annular seal and the second annular seal at the annular sealing face of the housing component, said annular sealing face having a annular trench therein extending around the fluid flow conduit, the trench vented to the exterior of the housing;

22. The sensor of claim 21 wherein the first annular seal and second annular seal comprise O-rings.

23. The sensor of claim 21 wherein the first annular seal and second annular seal are integral with the annular sealing face of the housing component and are configured as curved ridges.

24. An operative fluid device comprising a fluoropolymer housing component with a annular sealing face surrounding a fluid flow conduit, a pair of annular seals engaged with the sealing face and concentrically positioned with respect to the fluid flow conduit, the annular face having a trench therein with a vent through the housing component to the exterior of the housing component.
